(19) United States
(12) Patent Application Publication
(10) Pub. No.: US 2013/0012145 A1
(43) Pub. Date: Jan. 10, 2013

(54) RADIO MODULE AND MANUFACTURING METHOD THEREFOR

(75) Inventors: Akinobu Shibuya, Tokyo (JP); Akira Ouchi, Tokyo (JP); Akira Miyata, Tokyo (JP); Ryo Miyazaki, Tokyo (JP); Yoshiaki Wakabayashi, Tokyo (JP)

(73) Assignee: NEC Corporation

(21) Appl. No.: 13/636,576

(22) PCT Filed: Mar. 15, 2011
(86) PCT No.: PCT/JP2011/056689

§ 371 Date: Sep. 21, 2012

(30) Foreign Application Priority Data
Mar. 24, 2010 (JP) 2010 068127

(51) Int. Cl. H04B 1/38

(52) U.S. Cl. 455/90.3

(57) ABSTRACT

Provided is a radio module that includes a radio signal connection portion having a low insertion loss and high reliability.

This radio module includes a first wiring substrate 1, and a second wiring substrate 2 which is located opposite to a first face 1a of the first wiring substrate 1. Further, at least one through hole 3 having an inner wall formed of a conductive material is provided inside the second wiring substrate. Moreover, at least one hollow pillar 4 formed of a conductive material is provided at a position corresponding to the at least one through hole 3, on at least one of the first face 1a and a second face 2a of the second wiring substrate 2, the second face 2a being opposite to the first face 1a. Here, an axis-direction height of the at least one hollow pillar 4 formed of a conductive material is smaller than the width of a gap between the first face 1a and the second face 2a. Further, one end face of the at least one hollow pillar 4 formed of a conductive material is not fixed, and a radio signal passes through a hollow portion of the at least one pillar.

### TECHNICAL FIELD

The present invention relates to a radio module and a manufacturing method therefor.

### BACKGROUND ART

In recent years, it has been attempted to assemble an equipment by means of a method of mounting high-frequency IC packages on a motherboard thereof in the light of process shortening or cost reduction. In Japanese Patent Publication No. 3969321 (Patent Literature 1), a high-frequency IC package has been made leadless. In the structure of such a high-frequency IC package as described in Patent Literature 1, a semiconductor device is electrically connected to the lines of a multilayer dielectric substrate via metallic wires, and is covered by a metallic frame and a lid for air sealing. This high-frequency IC package is electrically connected to a resin substrate by means of solder bumps. High-frequency signals of the high-frequency IC package are outputted and inputted, through the multilayer dielectric substrate, to/from waveguides included in a waveguide circuit, which is provided under the resin substrate, via spaces each being surrounded by the solder bumps, and the resin substrate. Subsequently, the high-frequency signals of the high-frequency IC package are electrically connected to an antenna via the waveguides. Further, other signal terminals, grounding terminals and bias terminals are electrically connected to the resin substrate via the corresponding solder bumps. An advantage of this structure is that the throughput of a connection process therefor is higher as compared with that of a lead connection process. Besides, the alignment of the waveguides connection is also performed by the self-alignment of the solder bumps, and thus, the assembly cost can be reduced.

Further, in Japanese Unexamined Patent Application Publication No. 2002-164465 (Patent Literature 2), with respect to a dielectric substrate on which high-frequency components are mounted, waveguide pads are provided on a face opposite the face on which the high-frequency components are mounted. These waveguide pads of the dielectric substrate and waveguide pads provided for waveguides of a dielectric board are connected to each other by means of a brazing material.
Patent Literature 1: Japanese Patent Publication No. 3969321
Patent Literature 2: Japanese Unexamined Patent Application Publication No. 2002-164465

### SUMMARY OF INVENTION

### Technical Problem

In Patent Literature 1, by appropriately disposing the solder bumps, the insertion loss of high-frequency radio signals passing through connection portions (i.e., the spaces each being surrounded by the solder bumps) between the high-frequency IC package multilayer dielectric substrate and the resin substrate is reduced.

However, there has been a problem that the insertion loss increases because the high-frequency radio signals spread into a gap (a gap whose width is equivalent to the thickness of the solder) between the multilayer dielectric substrate and the resin substrate. Meanwhile, in the structure described in Patent Literature 2, in which the waveguide pads of the dielectric substrate and the corresponding waveguide pads of the dielectric board are connected to each other by means of a brazing material, the insertion loss of high-frequency radio signals is small. However, there has been a problem that, because of a difference in the coefficient of thermal expansion between each of the dielectric substrate for IC package and the dielectric board, and the brazing material, stress occurs on brazed high-frequency signal connection portions, and thus, the reliability is low.

An object of the present invention is to solve the problems described above, and provide a radio module and a manufacturing method therefor which enable realization of a radio signal connection portion thereof having a small insertion loss and high reliability.

### Solution to Problem

A radio module according to an aspect of the present invention includes a first wiring substrate; a second wiring substrate which is located opposite to a first face of the first wiring substrate; at least one through hole which is provided inside the second wiring substrate, and which has an inner wall formed of a conductive material; and at least one hollow pillar which is provided on at least one of the first face and a second face of the second wiring substrate, the second face being opposite to the first face, and is provided at a position corresponding to the at least one through hole, and which is formed of a conductive material, and an axis-direction height of the at least one pillar is smaller than the width of a gap between the first face and the second face; one end face of the at least one pillar is not fixed; and a radio signal passes through a hollow portion of the at least one pillar.

A manufacturing method for a radio module, according to another aspect of the present invention, includes a process of forming at least one hollow pillar formed of a conductive material on at least one of a first face of a first wiring substrate and a second face of a second wiring substrate, the second face being opposite to the first face; and a process of forming at least one through hole inside the second wiring substrate, and forming a conductive material on an inner wall of the at least one through hole.

### Advantageous Effects of Invention

According to the present invention, the insertion loss of a radio signal connection portion can be made small, and the reliability thereof can be made high.

### BRIEF DESCRIPTION OF DRAWINGS

FIG. 1 is a sectional view of a radio module according to an embodiment of the present invention.

FIG. 2 is a sectional view of a radio module according to an embodiment of the present invention.

FIG. 3 is a sectional view of a radio module according to an embodiment of the present invention.

FIG. 4 is a plan view of a first face 1a of a first wiring substrate according to an embodiment of the present invention.

FIG. 5 is a plan view of a first face 1a of a first wiring substrate according to an embodiment of the present invention.

FIG. 6 is a plan view of a first face 1a of a first wiring substrate according to an embodiment of the present invention.

FIG. 7 is a plan view of a second face 2a of a second wiring substrate according to an embodiment of the present invention.

FIG. 8 is a sectional view illustrating a manufacturing method for a radio module according to an embodiment of the present invention.

FIG. 9 is a sectional view of a radio module according to an embodiment of the present invention.

FIG. 10 is a sectional view illustrating a manufacturing method for a radio module according to an embodiment of the present invention.

FIG. 11 is a plan view of a solder connection face of a waveguide connection model according to a practical example of the present invention.

FIG. 12 is a perspective sectional view of a waveguide connection model according to a practical example of the present invention.

FIG. 13 is a graph of results of insertion loss calculations with respect to a waveguide connection model according to a practical example of the present invention and a comparison example thereof.

### DESCRIPTION OF EMBODIMENTS

### First Embodiment

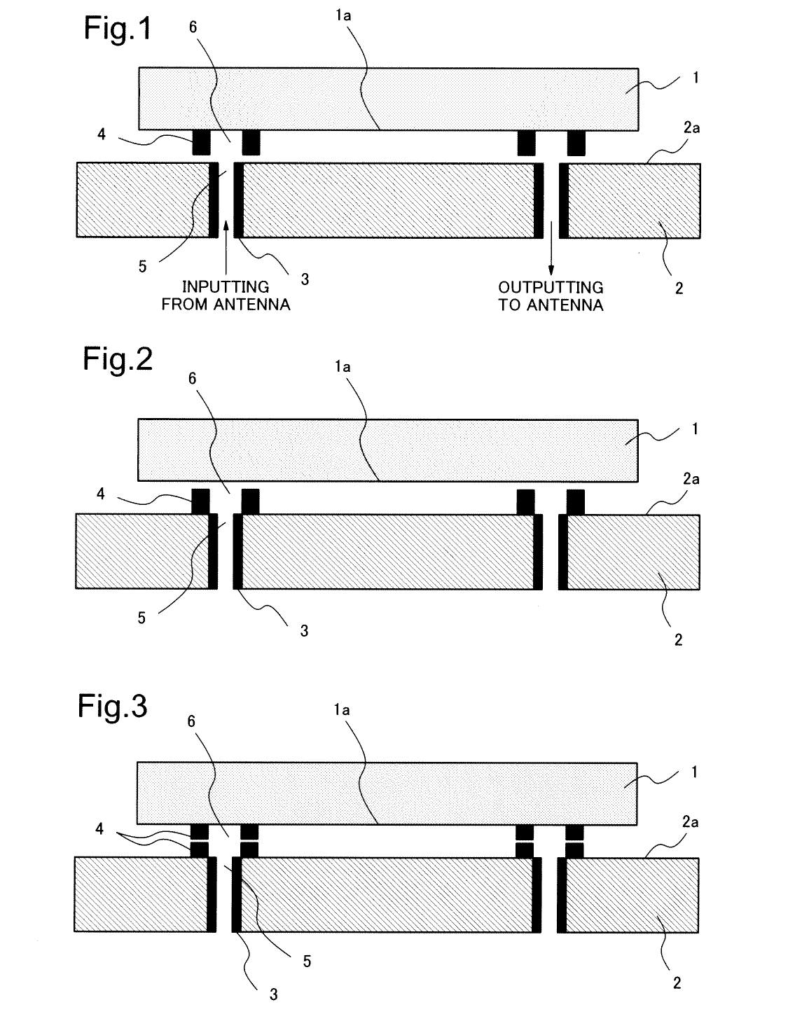

A radio module according to a first embodiment of the present invention will be described. FIGS. 1 to 3 each illustrate a sectional view of the radio module according to the first embodiment of the present invention. The radio module shown in FIG. 1 includes a first wiring substrate 1, and a second wiring substrate 2 which is located opposite to a first surface 1a of the first wiring substrate 1. Moreover, through holes 3, each having an inner wall formed of a conductive material, are provided inside the second wiring substrate 2. Further, hollow pillars 4 formed of a conductive material are provided at the positions which are located on at least one of the first face 1a of the first wiring substrate 1 and a second surface 2a of the second wiring substrate 2 (the second surface 2a being opposite to the first surface), and which correspond to the respective through holes 3. Here, the axis-direction height of each of the hollow pillars 4 formed of a conductive material is smaller than the width of a gap between the first surface 1a and the second surface 2a. Further, one end face of each of the hollow pillars 4 formed of a conductive material is not fixed, and a radio signal passes through each of the hollow portions of the pillars.

Hereinafter, “the hollow pillar 4 formed of a conductive material” will be abbreviated and referred to as “the hollow pillar 4”. However, there are no changes in the fact that “the hollow pillar 4” is formed of a conductive material. Further, “the through-hole 3 having an inner wall formed of a conductive material” will be abbreviated and referred to as “the through-hole 3”. However, there are no changes in the fact that “the through-hole 3” has an inner wall formed of a conductive material.

In FIG. 1, the hollow pillars 4 are provided on the first face 1a of the first wiring substrate 1. In FIG. 2, the hollow pillars 4 are provided on the second face 2a of the second wiring substrate 2. In FIG. 3, the hollow pillars 4 are provided on the first wiring substrate 1 and the second wiring substrate 2. In the case of FIG. 3, the sum of the heights of the both hollow pillars 4 is smaller than the width of a gap between the first face 1a and the second face 2a. The first wiring substrate 1 and the second wiring substrate 2 are fixed by a fixing portion which is not illustrated. The fixing portion and each of the wiring substrates may be electrically connected or may not be electrically connected to each other.

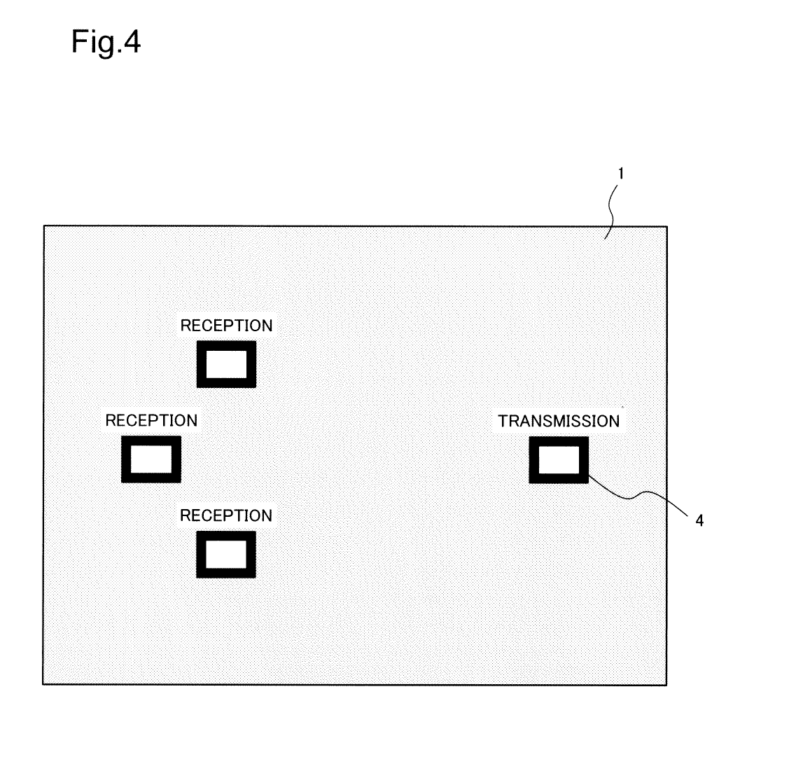

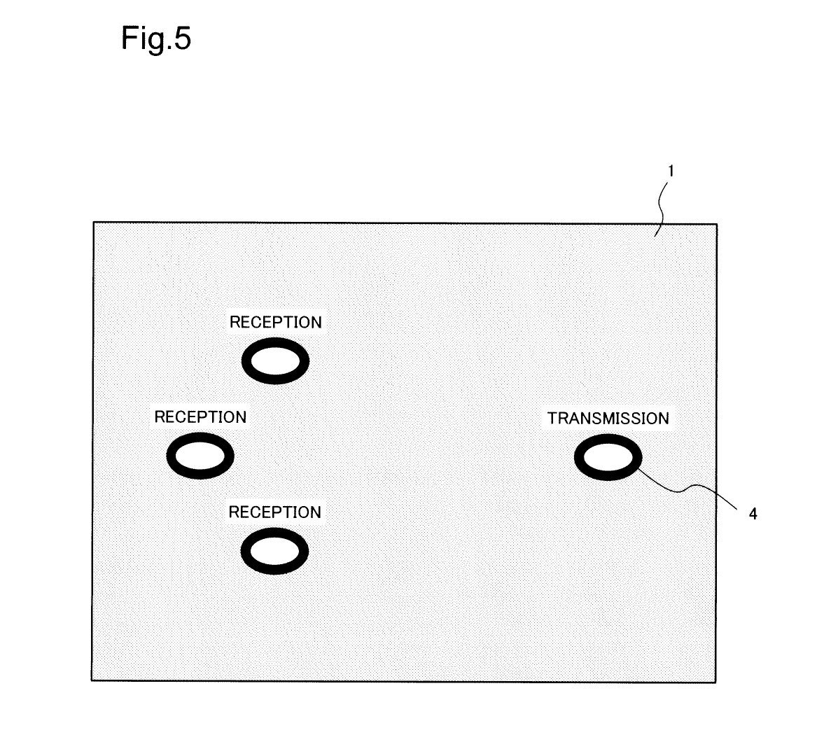

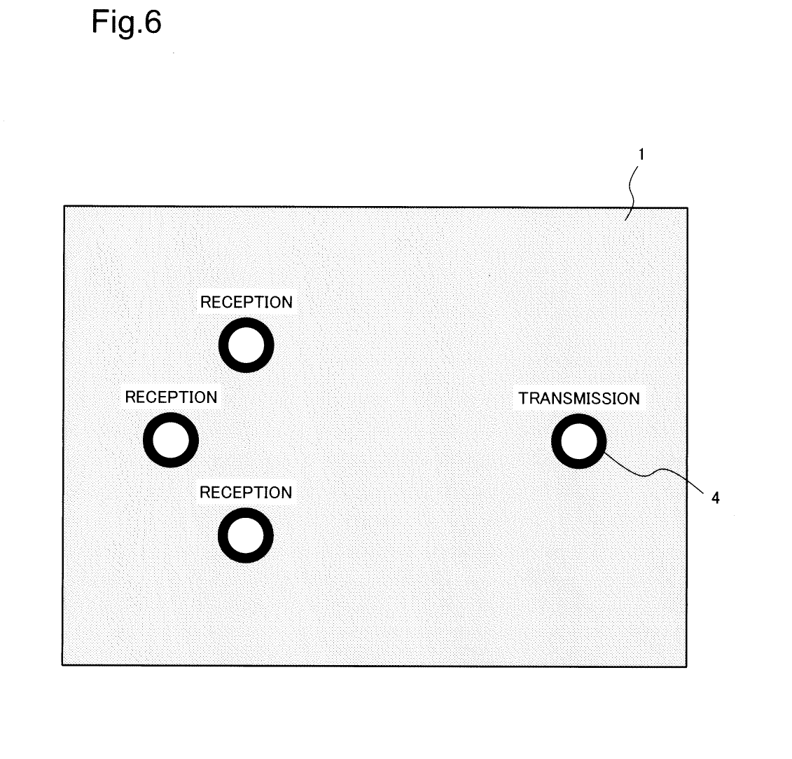

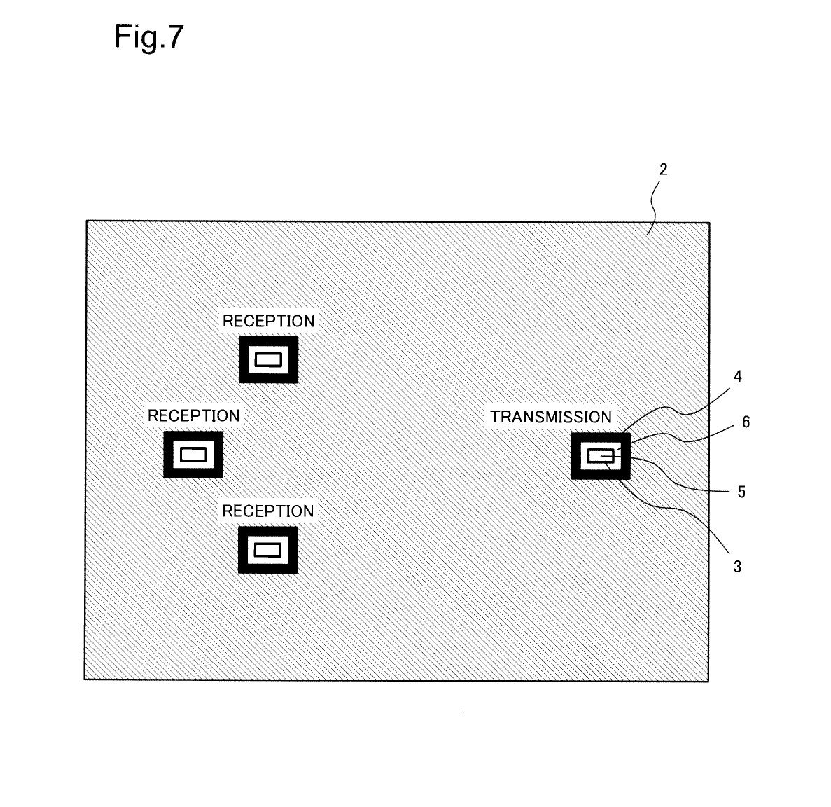

FIGS. 4 to 6 each illustrate a plan view of the first face 1a in the case where the hollow pillars 4 are provided on the first face 1a. As shown in FIGS. 4 to 6, the shape and size of the opening of each of the hollow pillars 4 are not limited. For example, a rectangular shape shown in FIG. 4, an elliptical shape shown in FIG. 5 or a circular shape shown in FIG. 6 is suitably employed. FIG. 7 illustrates a plan view of the second face 2a in the case where the hollow pillars 4 are provided on the second surface 2a of the second wiring substrate 2. FIG. 7 illustrates a case where each of the hollow pillars 4 forms a rectangular shape. In FIGS. 4 to 7, one transmission channel and three reception channels are illustrated, but the number of the transmission channels and the number of the reception channels are not limited.

High-frequency signals outputting from electronic parts (not illustrated) of the first wiring substrate 1 pass through the hollow portions of the hollow pillars 4 to be outputted to the corresponding through holes 3 of the second wiring substrate 2, and subsequently, are outputted to externals (not illustrated) from an antenna. Conversely, high-frequency signals inputting from externals (not illustrated) to the through holes 3 via an antenna pass through the hollow portions of the corresponding hollow pillars 4, and are inputted to the first wiring substrate 1.

In addition, the electronic parts outputting and inputting the high-frequency signals may be provided on the first wiring substrate 1, or may be provided inside the first wiring substrate 1. There is no problem, provided that the electronic parts are mounted at the positions where the high-frequency signals outputting and inputting from/to the electronic parts pass through the hollow pillars 4.

As shown in FIG. 1, in the case where the hollow pillars 4 are provided on the first wiring substrate 1, the high-frequency signals outputting from the electronic parts (not illustrated) of the first wiring substrate 1 transmit inside the hollow portion of the hollow pillar 4. Therefore, the cross-sectional area of a transmission path of the high-frequency signals does not become larger than that of the hollow portion of the hollow pillar 4. Further, although the cross-sectional area of the transmission path of the high-frequency signals increases at the gap portion between the end portion of the second wiring substrate 2 side of the hollow pillar 4 and the through hole 3, the increase amount thereof is small because the width of the gap portion is small. Therefore, a large proportion of high-frequency signals out of the high-frequency signals outputting from the hollow pillar 4 is coupled to the through hole 3. That is, it is possible to obtain an advantageous effect in that the loss is reduced.

Further, when the high-frequency signals inputting from externals to the through hole 3 output from the second surface 2a of the second wiring substrate 2 toward the hollow pillar 4, the cross-sectional area of a transmission path of the high-frequency signals increases. However, the increase amount thereof is small because the through hole 3 and the hollow pillar 4 are provided so as to have a small-width gap therebetween. Therefore, a large portion of high-frequency signals out of the high-frequency signals outputting from the through hole 3 is coupled to the hollow pillar 4. That is, it is possible to obtain an advantageous effect in that the loss is reduced.

Further, the hollow pillars 4 shown in FIG. 1 are fixed to only the first wiring substrate 1, and are not fixed to the second wiring substrate 2. Therefore, even if a difference in the coefficient of thermal expansion occurs between the hollow pillar 4 and the second wiring substrate 2, any stress does not occur between the hollow pillar 4 and the second wiring substrate 2, so that it is possible to obtain high reliability. On the other hand, with respect to wiring substrates shown in FIG. 3 of Patent Literature 2, two kinds of substrates are fixed to each other by means of a brazing operation, and thus, because of a difference in the coefficient of thermal expansion between each of the dielectric substrate and the dielectric board, and a brazing material, stress occurs on fixed portions, so that the reliability is reduced.

In the case of FIGS. 2 and 3, similarly, one end face of each of the hollow pillars 4 is not fixed. Accordingly, even if a difference in the coefficient of thermal expansion occurs between the hollow pillar 4 and a wiring substrate opposing the hollow pillar 4, any stress does not occur between the hollow pillar 4 and the wiring substrate opposing the hollow pillar 4, and thus, it is possible to obtain high reliability.

Hereinbefore, the case where high-frequency signals are handled has been described, but handled signals are not limited to the high-frequency signals. Therefore, it is possible to allow radio signals of arbitrary frequencies to pass through the coupling portions between the through holes 3 and the hollow pillars 4.

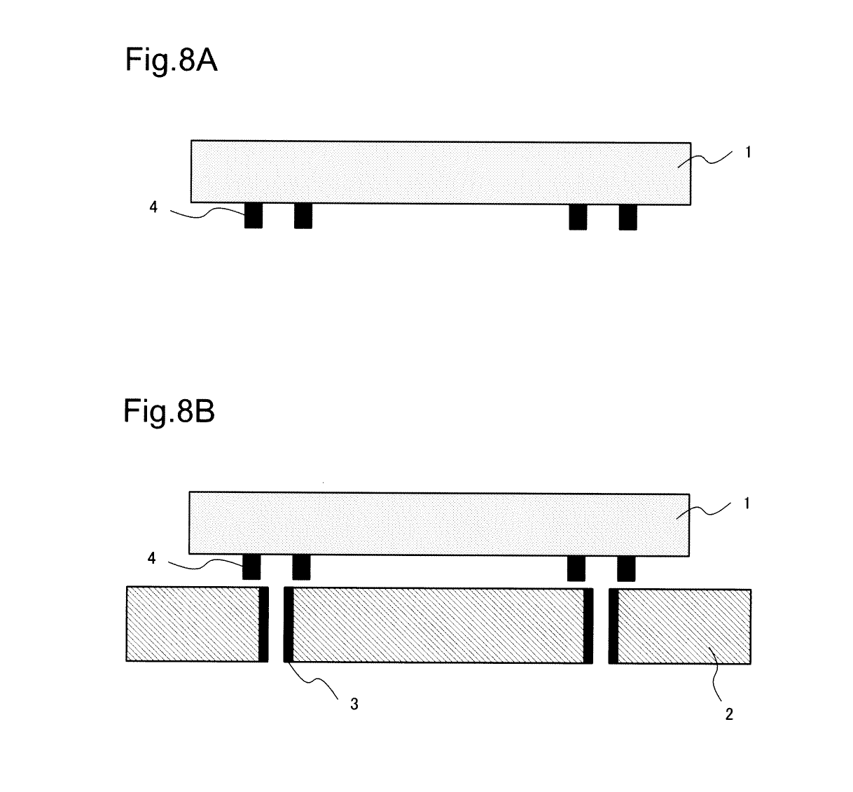

A manufacturing method for a radio module according to this embodiment will be described by using the structure shown in FIG. 1. First, as shown in FIG. 8 (A), the hollow pillars 4 are formed on the first face 1a of the first wiring substrate 1. For example, metallic foil is stuck onto the first wiring substrate 1, and etching is performed so as to leave portions to be the hollow pillars 4 as they are. Alternatively, a conductive resin is applied via a mask including portions each having the same shape as that of the hollow pillar 4, and heat processing is performed, whereby the hollow pillars 4 are formed. Next, as shown in FIG. 8 (B), holes are formed so as to cause the holes to penetrate the second wiring substrate 2. For example, the holes are made by performing drilling or laser processing, and a conductive material is formed inside each of the holes by performing plating, sputtering or vapor deposition. Further, as shown in FIG. 8 (A), the first wiring substrate 1, on which the hollow pillars 4 have been formed, and the second wiring substrate 2, inside which the through holes 3 have been formed, are located and fixed so as to cause the positions of the hollow pillars 4 and those of the through holes 3 to correspond to each other. In this case, the first wiring substrate 1 and the second wiring substrate 2 are located and fixed such that each of the hollow pillars 4 and the through hole 3 corresponding thereto have a gap of a predetermined width therebetween.

According to the above-described manufacturing method, it is possible to manufacture a radio module, which enables electrical connection and high-frequency signal connection, in a simple process.

### Second Embodiment

In a second embodiment according to the present invention, as shown in FIG. 7, an opening 6 of each of the hollow pillars is configured to include an opening 5 of the corresponding through hole when the second wiring substrate 2 is viewed from the direction substantially perpendicular to the second face 2a (from the upper direction). Although, here, the structure in which the hollow pillars 4 shown in FIG. 2 are provided on the second wiring substrate 2 is illustrated, besides, the hollow pillars 4 may be disposed such as shown in FIG. 1 or FIG. 3.

The opening 6 of the hollow pillar is configured to include the opening 5 of the through hole, whereby substantially all of high-frequency signals out of the high-frequency signals outputting from the through hole 3 are coupled to the hollow pillar 4. That is, it is possible to obtain an advantageous effect in that the loss is reduced. Further, with respect to the high-frequency signals outputting from the hollow pillar 4, similarly, substantially all of high-frequency signals out of them are coupled to the through hole 3. That is, it is possible to obtain an advantageous effect in that the loss is reduced.

### Third Embodiment

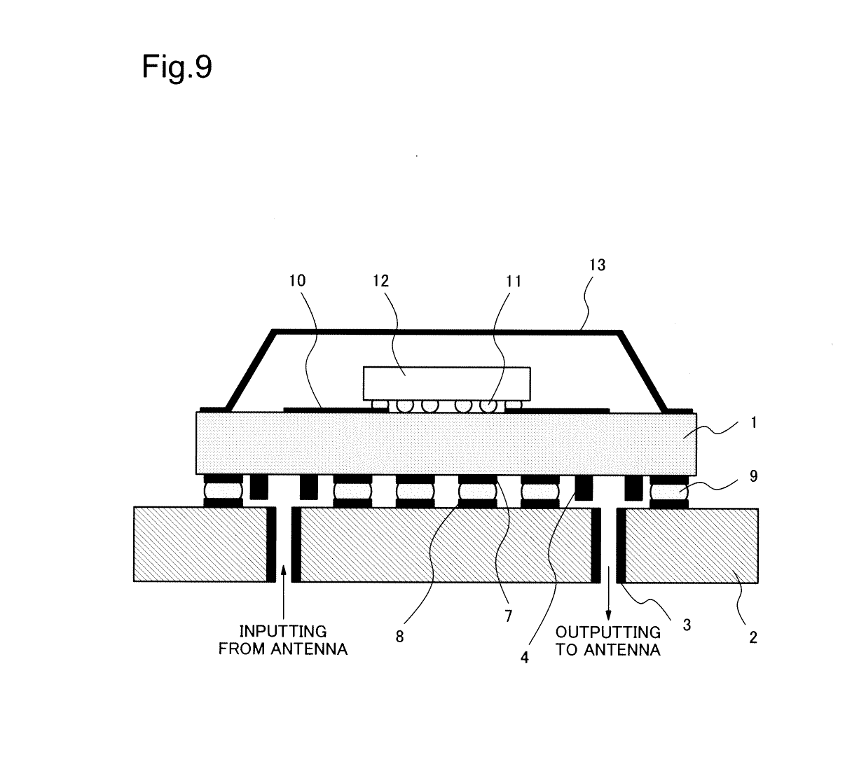

A third embodiment according to the present invention will be described by using FIG. 9. FIG. 9 is a sectional view of a radio module. Descriptions of the portions having been hereinbefore described using FIG. 1 will be omitted.

The radio module has first electrodes 7 on the first face 1a shown in FIG. 1, and has second electrodes 8 corresponding to the respective first electrodes 2 on the second surface 2a shown in FIG. 1. In addition, the first electrodes 7 and the second electrodes 8 corresponding thereto are connected to each other via conductive materials 9. Further, the radio module is equipped with waveguides 10 on, out of the faces of the first wiring substrate 1, the face opposite the face electrically connected via the conductive materials 9. Further, a semiconductor device 12 is electrically connected to the first wiring substrate 1 via bonding materials 11 on the waveguides 10. Nothing may be electrically connected to, out of the ends of each of the waveguides 10, the end opposite the end connected to the semiconductor device 12. Further, a via hole may be connected to, out of the ends of each of the waveguides 10, the end opposite the end connected to the semiconductor device 12. Further, an antenna electrode may be provided on the first face 1a of the first wiring substrate 1 so as to correspond to the position of, out of the ends of each of the waveguides 10, the end opposite the end connected to the semiconductor device 12. Moreover, a cover 13 is provided so as to cover the semiconductor device 12, and seals the semiconductor device 12. In the structures shown in FIGS. 2 and 3, similarly, the waveguides 10, the jointing materials 11, the semiconductor device 12 and the cover 13, which have been described above, can be provided.

By connecting the first electrodes 7 of the first wiring substrate 1 and the corresponding second electrodes 8 of the second wiring substrate 2 by means of the conductive materials 9, the connection of a plurality of electric signals, such as a power supply and an IF signal, is made possible Further, it is possible to fix the first wiring substrate 1 and the second wiring substrate 2 along with keeping the gap therebetween constant.

The coplanar line is suitable for the form of the waveguide 10 of the first wiring substrate 1. As a result, it is possible to obtain an advantageous effect in that a high-frequency signal transmission loss is small and heat dissipation is good.

For the method of connecting the semiconductor device 12, a flip chip connection method or a wire bonding method is employed. In particular, in the case where signals of the millimeter-wave band are transmitted and received, by employing the flip chip connection method, the transmission loss occurring at connection portions can be made small.

The material of the bonding material 11 employed when the semiconductor device 12 is connected by means of the flip chip connection method is not limited, but gold stud bumps or solder bumps are suitable. Further, the kind, size and number of the semiconductor device 12 and the size and pitch of the bonding material 11 are not limited.

It is possible to provide the cover 13 on the face on which the semiconductor device 12 is mounted, and seal the semiconductor device 12. By sealing the semiconductor device 12, it is possible to suppress electromagnetic interference (EMI) and spurious waves (unwanted radio waves not targeted).

Further, an underfill material may be provided for only the conductive material 9 portions except for the hollow pillars 4 and the through holes 3. Further, part of the hollow pillar 4 may be cut.

As shown in FIG. 9, high-frequency signals outputting from the semiconductor device 12 transmit through the waveguide 10 via the jointing materials 11. Further, the direction of movement of this high-frequency signals is converted to the direction to the first face 1a of the first wiring substrate 1 at the end portion of the waveguide 10. Subsequently, the high-frequency signals pass through the hollow pillar 4 and the through hole 3, and are outputted to externals (not illustrated) from an antenna. High-frequency signals inputting from externals to the through hole 3 via the antenna pass through the hollow pillar 4, the waveguide 10 and the bonding materials 11, and are inputted to the semiconductor device 12.

Next, a manufacturing method for the radio module will be described. First, the hollow pillars 4 are formed on the first wiring substrate 1 just like in the case of FIG. 8 (A). Moreover, the first electrodes 7 and the waveguides 10 are formed. Next, holes penetrating the second wiring substrate 2 are formed just like in the case of FIG. 8 (B). A conductive material, such as copper, nickel or gold, is formed on the inner wall of each of the through holes 3. Moreover, the second electrodes 8 are formed. The first electrodes 7, the waveguides 10 and the second electrodes 8 can be formed by performing etching of metallic foil or the like, or plating.

Next, the semiconductor device 12 is mounted on the waveguides 10 of the first wiring substrate 1 by using the bonding materials 11, and the cover 13 is jointed to the first wiring substrate 1.

Next, the conductive materials 9 are formed on the respective first electrodes 7 of the first wiring substrate 1. For example, in the case where each of the conductive materials 9 is a ball, the ball is supplied on each of the first electrodes 7 by using a ball feeding apparatus. In the case where each of the conductive materials 9 is a conductive resin, the conductive resin may be printed via a mask. Next, the first electrodes 7 of the first wiring substrate 1 and the corresponding second electrodes 8 of the second wiring substrate 2 are connected to each other by using the conductive materials 9. For example, the conductive materials 9 of the first wiring substrate 1 and the corresponding second electrodes 8 of the second wiring substrate 2 can be aligned by using a flip chip mounter. In addition, the conductive materials 9 may be formed on the corresponding second electrodes 8 of the second wiring substrate 2.

In the case where the hollow pillars 4 shown in FIG. 2 are formed on the second substrate, processing can be performed such that, in the process shown in FIG. 8(B), first, the hollow pillars 4 are formed, and subsequently, the through holes 3 are formed. In the case where the hollow pillars 4 shown in FIG. 3 are formed, a similar process can be used.

According to the above-described manufacturing method, it is possible to manufacture a radio module, which enables electrical connection and high-frequency signal connection, in a simple process.

### Fourth Embodiment

In a fourth embodiment of the present invention, a material suitable for the hollow pillar 4 will be described. It is desirable that the material of the hollow pillar 4 is the same as that of the electrode of the first wiring substrate 1. In the case where the first wiring substrate 1 is a printed wiring board, electrodes thereof are formed of a copper material, and thus, similarly, the copper material is suitably used for the hollow pillars 4. The case where the hollow pillars 4 are formed on the second wiring substrate 2 is similar. The hollow pillars 4 may be formed by performing a surface treatment, such as gold plating, on the copper material.

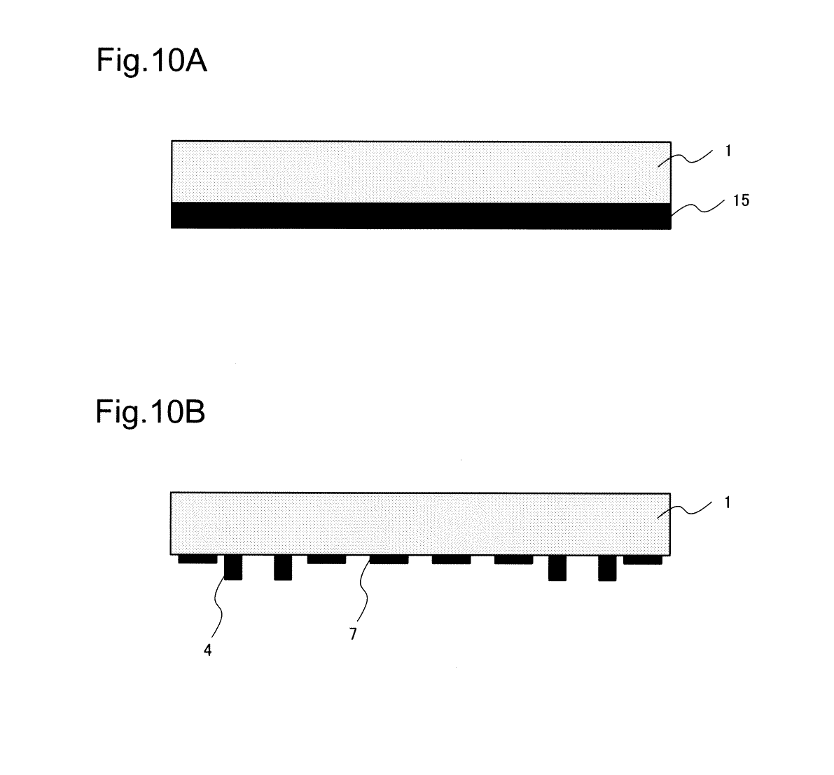

In the case where the hollow pillars 4 are formed of a copper material, the electrodes and the hollow pillars 4 can be formed in a lump in the process of forming the electrodes. First, as shown in FIG. 10 (A), copper foil 15 having the same thickness as each of the target hollow pillars 4 is laminated on the face on which the hollow pillars 4 are to be formed. This thickness of the copper foil 15 is usually larger than that in the case of forming the electrodes.

Next, as shown in FIG. 10 (B), by etching the unused part of the copper foil 15, the hollow pillars 4 can be formed easily. Further, in the process of forming the hollow pillars 4, the hollow pillars 4 can be protected by means of a method of covering each of the hollow pillars 4 with a mask, or the like, thereby enabling increase of an etching amount with respect to only each of electrode portions. Through this process, each of the electrodes can be formed so as to have a predetermined thickness, and thus, the hollow pillars 4 and the first electrodes 7 can be formed during the same process.

In the case where the hollow pillars 4 made of a copper material are formed on the second wiring substrate 2, the same manufacturing method as that for the first wiring substrate 1 can be employed.

Further, it is also suitable to form the hollow pillars 4 by using a conductive resin. The hollow pillars 4 can be formed in a simple process by printing and hardening a conductive resin paste via a mask. Moreover, the hollow pillars 4 can be formed by performing jointing or adhesion.

### Fifth Embodiment

In a fifth embodiment according to the present invention, a case where the first wiring substrate 1 is an organic wiring substrate and the conductive material 9 is solder will be described.

For the first wiring substrate 1, the organic wiring substrate is desirable. Among the organic wiring substrates, it is desirable to employ a printed wiring board or a liquid crystal polymer (LCP) substrate containing polyphenylene ether (PPE) as its main component, which is a material having a small dielectric loss at high frequencies. Further, a low temperature co-fired ceramics (LTCC) substrate is also employed.

Since the hollow pillars 4 can connect high-frequency signals with low loss, the organic wiring substrate can be employed as the first wiring substrate 1, and thus, it is not necessary to employ a low-loss ceramic substrate. Moreover, in the case where both of the first wiring substrate 1 and the second wiring substrate 2 are the organic wiring substrates, such as printed wiring board, the coefficient of thermal expansion of the first wiring substrate 1 and that of the second wiring substrate 2 are substantially the same. Therefore, since stress occurring on each of the conductive materials 8 is small, it is possible to obtain high reliability. Additionally, it is also possible to obtain an advantageous effect in that cost reduction is achieved by employing the organic wiring substrate.

For the conductive material 9, it is desirable to employ the solder 14, and lead-free solder including a Sn—Ag—Cu based alloy is suitably employed.

The structure having the hollow pillars 4 brings an advantageous effect in that high-frequency signals can be connected with low loss, and further, the reliability of connection portions using the solder 14 can be made higher by making the solder 14 larger. On the other hand, in a high frequency transceiver module shown in FIG. 1 of Patent Literature 2, if, in order to make the reliability of a solder connection portion higher, the size of the solder is made larger, the gap between the two substrates becomes larger. If this gap becomes larger, there occurs a problem that the loss of high-frequency signals becomes larger. Conversely, in order to make the loss of high-frequency signals smaller, if the size of the solder is made smaller, there occurs a problem that the reliability of the solder connection portion becomes lower.

### Practical Example

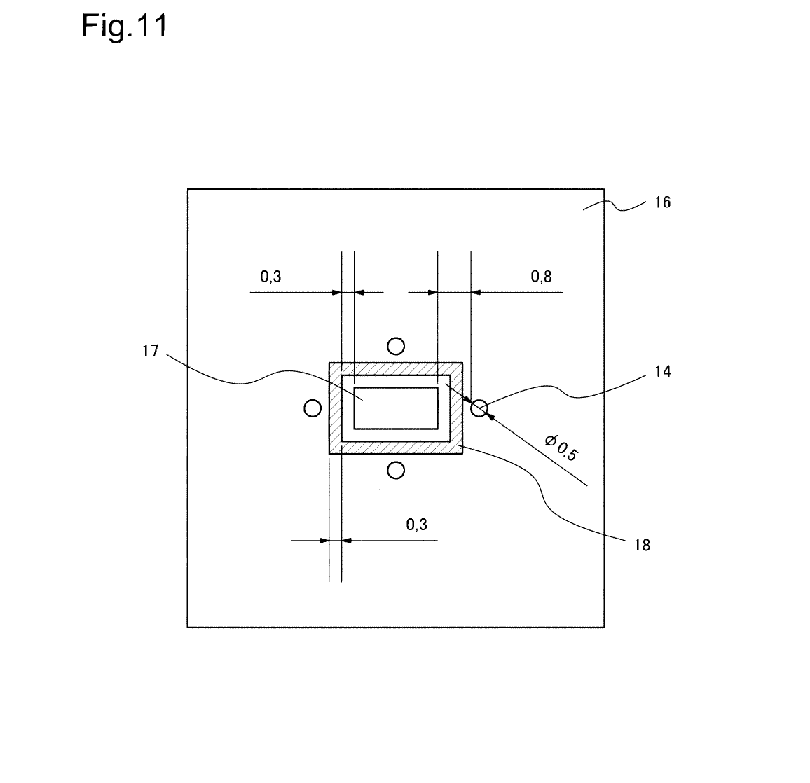

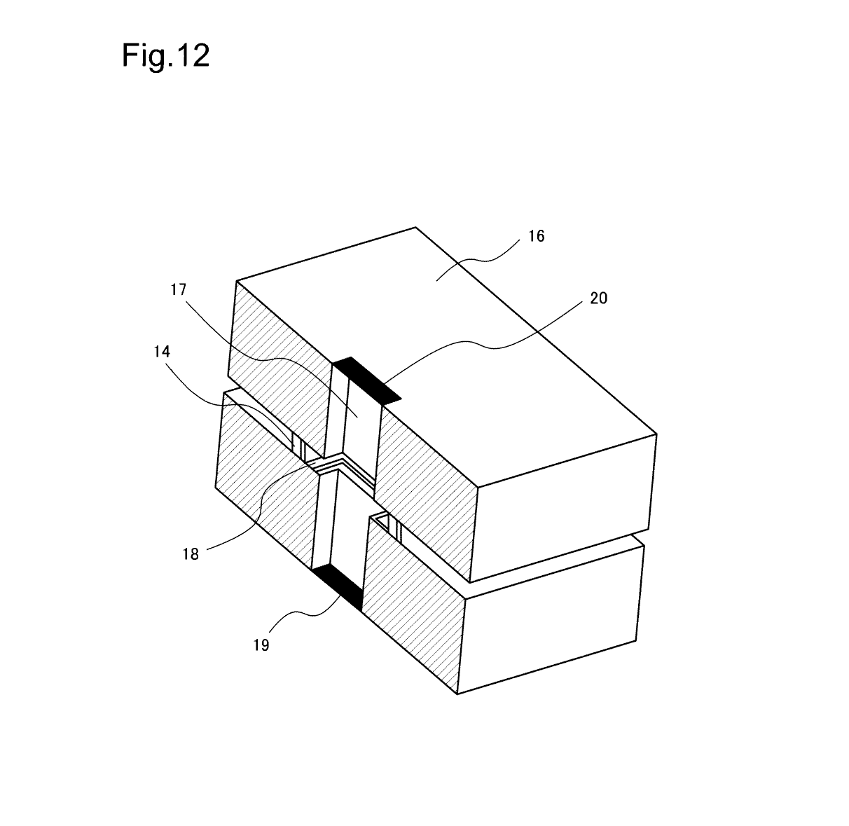

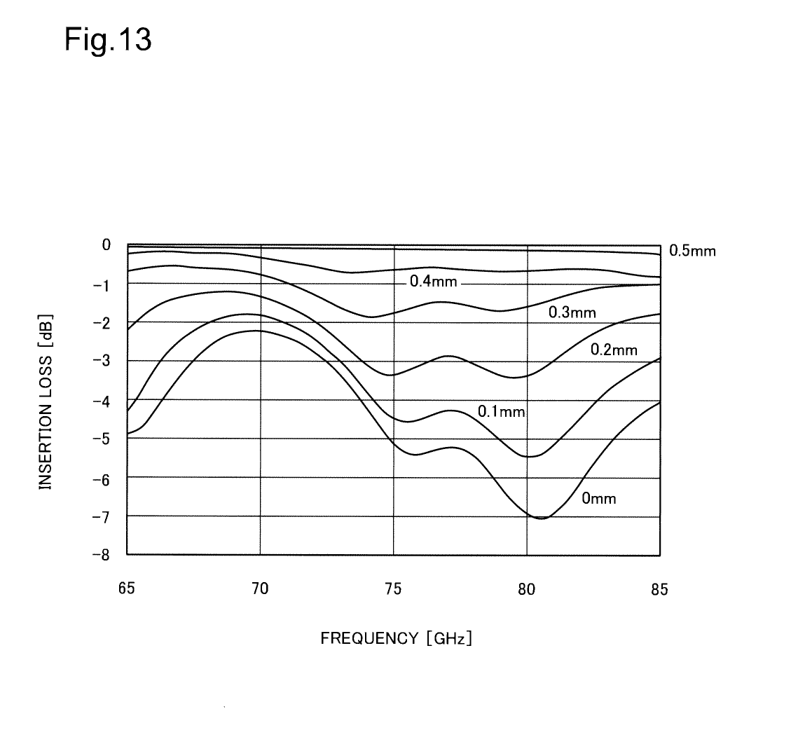

With respect to the transmission of high-frequency signals between the first wiring substrate 1 and the second wiring substrate 2, the advantageous effects dependent on the presence or absence of the hollow pillar 4 formed of a conductive material, according to the present invention, will be confirmed. For this purpose, electromagnetic field analyses were performed under the state where two waveguides 17 were connected to each other by using the solder 14, and a metal ring 18 was formed as the hollow pillar 4 on one of the waveguides 17. The waveguides 17 were employed as an example of a structure which fulfils the function of the through hole 3 having an inner wall formed of a conductive material. Its model is illustrated in a plan view shown in FIG. 11 and a perspective sectional view shown in FIG. 12. The outside size of one of metals 16 is 12 mm×12 mm, and the thickness thereof is 5 mm. The size of the through hole 3 is 2.54 mm×1.27 mm. The inside diameter of the metal ring 18 is 3.14 mm×1.87 mm, and the width thereof is 0.3 mm. Further, the analyses were performed at intervals of 0.1 mm within the range of the height of the metal ring 18 from 0 mm to 0.5 mm, and the results thereof were compared. Each piece of the solder 14 is formed in the cylindrical shape having the diameter of 0.5 mm and the height of 0.5 mm, and is provided for each side of the waveguide 17. Further, each piece of the solder 14 is located at the position from which the each side thereof is distanced by 0.8 mm. With respect to frequencies for the analyses, in the range from 65 GHz to 85 GHz of the millimeter-wave band, the analyses were performed, and in each of the analyses, an insertion loss between an input face 19 and an output face 20 shown in FIG. 12 was calculated. This result is shown in a graph of FIG. 13.

Further, in Table 1, a characteristic in that the insertion loss at the frequency of 76 GHz depends on the height of the hollow pillar 4 is shown. As is obvious from these results, as compared with a case where the hollow pillar 4 does not exist (i.e., a case where the height of the hollow pillar 4 is 0 mm), it can be understood that, by forming the hollow pillar 4, the insertion loss can be reduced to a greater degree. Moreover, it can be understood that the larger the height of the hollow pillar 4 becomes, the larger the advantageous effect thereof becomes. Although, in the case where the height of the hollow pillar 4 is 0.5 mm, the hollow pillar 4 touches the waveguide 17 provided at the side where the hollow pillars 4 are not formed, the calculation was performed to see the influence of the height of the hollow pillar 4. From this result, it has become apparent that it is further desirable to make the height of the hollow pillar 4 be close to the height of the piece of solder as much as possible.

TABLE 1

| | Height of Ring (mm) | | | | | |
|---|---|---|---|---|---|---|
| | 0 | 0.1 | 0.2 | 0.3 | 0.4 | 0.5 |
| Insertion Loss | −5.38 | −4.48 | −3.05 | −1.49 | −0.53 | −0.08 |
| (dB) | | | | | | |

Hereinbefore, preferred embodiments according to the present invention have been described, but these are just examples, and do not limit the present invention at all. Various changes can be made within the scope not departing from the gist of the present invention.

Further, with respect to the foregoing description, the following supplementary note is disclosed.

### (Supplementary Note 1)

A manufacturing method for a radio module includes a process of forming at least one hollow pillar formed of a conductive material on at least one of a first face of a first wiring substrate and a second face of a second wiring substrate, the second face being opposite to the first face, a process of forming at least one through hole inside the second wiring substrate, and forming a conductive material on an inner wall of the at least one through hole, and the process of forming at least one pillar includes a process of laminating copper foil on at least one of the first face of the first wiring substrate and the second face of the second wiring substrate, and a process of etching the copper foil.

This application insists on priority based on Japanese Application Japanese Patent Application No. 2010-68127 filed on Mar. 24, 2010 and the entire disclosure thereof is incorporated herein.

### REFERENCE SIGNS LIST

1: First wiring substrate
1a: First face
2: Second wiring substrate
2a: Second face
3: Through hole
4: Hollow pillar
5: Opening of through hole
6: Opening of hollow pillar
7: First electrode
8: Second electrode
9: Conductive material
10: Waveguide
11: Jointing material
12: Semiconductor device
13: Cover
14: Solder
15: Copper foil
16: Metal
17: Waveguide
18: Metal ring
19: Input face
20: Output face

1. A radio module comprising: a first wiring substrate;
a second wiring substrate which is located opposite to a first face of the first wiring substrate;
at least one through hole which is provided inside the second wiring substrate, and which has an inner wall formed of a conductive material; and
at least one hollow pillar which is provided on at least one of the first face and a second face of the second wiring substrate, the second face being opposite to the first face, and is provided at a position corresponding to the at least one through hole, and which is formed of a conductive material,
wherein an axis-direction height of the at least one pillar is smaller than the width of a gap between the first face and the second face, one end face of the at least one pillar is not fixed, and a radio signal passes through a hollow portion of the at least one pillar.

2. The radio module according to claim 1, wherein an opening of the at least one pillar includes an opening of the at least one through hole when viewed from a direction perpendicular to the second face.

3. The radio module according to claim 1 or claim 2, further comprising:
at least one first electrode which is provided on the first face;
at least one second electrode which is provided on the second face so as to correspond to the at least one first electrode; and
at least one conductive material which connects the at least one first electrode and the at least one second electrode.

4. The radio module according to claim 1, further comprising at least one coplanar line which is provided on a face opposite the first face of the first wiring substrate.

5. The radio module according to claim 1, further comprising at least one semiconductor device which is flip-chip connected to a face opposite the first face of the first wiring substrate.

6. The radio module according to claim 1, further comprising at least one cover which seals the at least one semiconductor device, and which is provided on a face opposite the first face of the first wiring substrate.

7. The radio module according to claim 1, wherein the at least one pillar is formed of copper.

8. The radio module according to claim 1, wherein the first wiring substrate is an organic wiring substrate.

9. The radio module according to claim 1, wherein the at least one conductive material, which connects the at least one first electrode and the at least one second electrode, is solder.

10. A manufacturing method for a radio module, the method comprising:
a process of forming at least one hollow pillar formed of a conductive material on at least one of a first face of a first wiring substrate and a second face of a second wiring substrate, the second face being opposite to the first face; and
a process of forming at least one through hole inside the second wiring substrate, and forming at least one conductive material on an inner wall of the at least one through hole.
